(19) United States
(12) Patent Application Publication
(10) Pub. No.: US 2026/0328033 A1
(43) Pub. Date: Oct. 22, 2026

(54) SWINGING-SLIDING DOOR SYSTEM OF A VEHICLE

(71) Applicant: KNORR-BREMSE GESELLSCHAFT MIT BESCHRANKTER HAFTUNG, Modling (AT)

(72) Inventors: Reinhold JAROLIM, Weyer (AT); Michael ERNST, Kematen/Ybbs (AT); Heinz ZARL, Zeillern (AT); Christian KALTEIS, Scheibbs (AT); Manuel SCHOEN, Kematen/Ybbs (AT)

(21) Appl. No.: 19/645,375

(22) Filed: Apr. 13, 2026

Related U.S. Application Data
(63) Continuation of application No. PCT/EP2024/082122, filed on Nov. 13, 2024.

(30) Foreign Application Priority Data
Nov. 29, 2023 (AT) A138/2023

(51) Int. Cl. E05D 15/10; B61D 19/00; E05F 15/655

(52) U.S. Cl. CPC E05D 15/1007; B61D 19/008; E05D 15/1068; E05F 15/655; E05D 2015/1026; E05Y 2201/22; E05Y 2201/626; E05Y 2201/684; E05Y 2900/51

(57) ABSTRACT

A swinging-sliding door system of a vehicle including a door frame, including a door opening; a door leaf, configured to open and close the door opening; a drive, configured to drive the door leaf relative to the door frame along a path including a linear portion, and an arc-shaped or curved portion; a guide- and locking device, configured to guide the door leaf and lock the door leaf at least in a closing position, the guide and locking device including a first guide- and locking element fixed at the door frame, a first pivot lever, supported in or at the door leaf, and supported slidable and pivotable by a first slotted link device relative to the first guide- and locking element, wherein the first slotted link device includes a first slotted link slider supported at or in a first slotted link guide and a second slotted link slider.

### RELATED APPLICATIONS

This application is a continuation of International patent application PCT/EP2024/082122, filed on Nov. 13, 2024, claiming priority from Austrian patent application A 138/2023, filed on Nov. 29, 2023, both of which are incorporated in their entirety by this reference.

### FIELD OF THE INVENTION

The invention relates to a swinging-sliding door system of a vehicle, in particular, a rail bound passenger transport vehicle, comprising a guide- and locking device for a door leaf according to the preamble of claim 1. The invention also relates to a vehicle with a swinging-sliding door system according to claim 21.

### BACKGROUND OF THE INVENTION

Guide- and locking devices for door leaves of swinging-sliding door systems of passenger transport vehicles are known in the art. They assure that leaves of one or two leaf swinging-sliding door systems close flush with an outer vehicle wall in a closed condition and that the door leaves are moveable along a path with a linear and a curved portion along an outer vehicle wall during opening and closing. Thus, the door leaves are driven by a drive. In particular, a closing position of the door leaves is to be kept stable by a locking position of the guide- and locking device, in particular, when forces are applied perpendicular to a longitudinal vehicle axis, wherein the forces are caused, in particular, by pressure differences when driving in tunnels or when passengers push at the door leaves.

A generic swinging-sliding door system, including a guide- and locking device, is disclosed in EP 2 071 110 B1. Thus, the guide- and locking device includes a pivot lever, which is supported by guide rollers in and at the door leaf at one end and supported at another end by a slotted link slider guided in slotted link guides, so that the pivot lever is slidable and pivotable in the slotted link guides. Thus, an axial first section of the slotted link slider is supported in a first linear slotted link guide (FIG. 4) in order to guide the slotted link slider in a longitudinal vehicle direction. An axial second section of the slotted link slider provided with an interlocking lug is guided parallel thereto in a second slotted link guide of a second guide element (FIG. 7), in order to support the slotted link slider in a locking position in a locking portion of the second slotted link guide when the slotted link slider is in a locking portion of the second slotted link guide and in order to facilitate a rotation of the pivot lever when the slotted link slider is in a pivot portion of the second slotted link guide (FIG. 8). Thus, the two axial sections of the slotted link slider are arranged coaxial.

It is detrimental that the interlocking lug only provides a rather short lever arm, wherein the rather short lever arm is exposed to the forces recited supra, so that a rather high surface pressure is provided at these locations, and in particular, deformations of an adjacent structure that are unavoidable during operations may cause the interlocking lug to move out of the locking portion. Additionally, the interlocking lug and the complimentary locking- and pivot portions of the second slotted link guide require small fabrication tolerances, which is detrimental for production cost. Additionally, variability of the pivot movement is limited in this embodiment and wear caused by the sliding movement is rather high.

### BRIEF SUMMARY OF THE INVENTION

Thus, it is an object of the instant invention to provide a swinging-sliding door system with a door leaf of a guide- and locking device for the door leaf, which assures a high level of locking safety of the door leaf combined with simple fabrication and a low amount of wear. Additionally, a vehicle with the swinging-sliding door system shall be provided.

According to the invention, the object is achieved by the features of claim 1 and claim 21.

The invention relates to a swinging-sliding door system of a vehicle, in particular, a people transport vehicle, the swinging-sliding door system comprising:
a) a door frame, including a door opening,
b) at least one door leaf, configured to open and close the door opening,
c) a drive, configured to drive the door leaf relative to the door frame, in particular, along a path including a linear portion, and an arc-shaped or curved portion,
d) a guide- and locking device, configured to guide the door leaf and lock the door leaf at least in a closing position, the guide and locking device including:
d1) at least one first guide- and locking element connected with the door frame, in particular, in a rigid manner,
d2) a first pivot lever, supported in or at the door leaf and supported slidable and pivotable by a first slotted link device relative to the first guide- and locking element, wherein the first slotted link device includes a first slotted link slider supported at or in the first slotted link guide and a second slotted link slider that cooperates with a second slotted link guide, wherein
e) the first slotted link guide includes a locking portion and a pivot portion, advantageously adjoining the locking portion, and wherein
f) the first slotted link slider is interlocked at or in the locking portion in the closed position of the door leaf, advantageously,
g) the second slotted link slider is non-coaxial with and offset from the first slotted link slider.

The second slotted link slider being arranged non-coaxial and offset from the first slotted link slider means, on the one hand, that the first slotted link slider and the second slotted link slider are not arranged coaxial like in EP 2 071 110 B1, but at a distance from one another. The first slotted link guide and the second slotted link guide can also be arranged without overlap. This means overlap-free. Alternatively, the first slotted link guide and the second slotted link guide can overlap at least partially.

This generates a larger lever arm between the first slotted link slider and the second slotted link slider, wherein the larger lever arm is advantageously better suitable to react the transversal forces described supra, in particular, in the closed position of the door leaf. Additionally, this also facilitates omitting the interlocking lugs of EP 2 071 110 B1, which facilitates using simpler cross-sectional shapes, in particular, for the first slotted link slider, e.g. a cylindrical cross-section which simplifies fabrication.

In particular, the door leaf driven by the drive device drives the first pivot lever during an opening process of the door leaf, wherein
a) the first pivot lever disengages the first slotted link slider from the locking portion, in particular, moves the first slotted link slider out of the locking portion and then engages the first slotted link slider with the pivot portion, wherein the first slotted link slider runs along the pivot portion, and thus
b) the first pivot lever moves the second slotted link slider along or at or in the second slotted link guide until the door leaf has reached its opening position.

In an advantageous embodiment, the door leaf driven by the drive drives the first pivot lever during a closing process of the door leaf,
a) wherein the first pivot lever disengages the first slotted link slider from the pivot portion and then engages the first slotted link slider in the locking portion, in particular, moves the first slotted link slider into the locking portion, and thus
b) the first pivot lever moves the second slotted link slider along or at or in the second slotted link guide until the door leaf has reached the closing position.

Advantageously, the locking portion includes a first, in particular, at least partially linear guide track, for the first slotted link slider, and/or the pivot portion includes an, in particular, at least partially curved support path for the slotted link slider.

Thereafter, the first slotted link slider can cooperate with the first at least partially linear guide track in the closed position of the door leaf, in particular, move into the first at least partially linear guide track, so that a movement of the door leaf at least perpendicular to the first, in particular, partially linear guide track is prevented.

The second slotted link guide can include a second, in particular, at least partially linear, guide track for the second slotted link slider or a guide track in which the second slotted link slider is then supported.

In particular, the at least partially curved guide track can deviate from a circular guide track and/or can have any curvature. This causes a high level of flexibility with respect to the pivot movement of the door.

In particular, the second slotted link slider forms a pivot axis of the first pivot lever when the door leaf is being moved, in particular, a door frame side pivot axis of the first pivot lever, wherein the first pivot lever then rotates about the door frame side pivot axis. Because the second slotted link slider is advantageously supported in the second linear guide track, it is advantageous when the first slotted link slider is supported at or in the pivot portion of the first slotted link guide in order to assure a defined support of the first pivot lever. Thus, the support of the first pivot lever is implemented by the support of the first slotted link slider in or at the first slotted link guide as well as by the cooperation of the second slotted link slider with the second slotted link guide during pivoting or rotation of the first pivot lever.

The first slotted link guide and the second slotted link guide can be arranged in a single plane or in different planes, in particular, offset from one another, wherein the planes may be parallel to each other. In particular, the first slotted link guide and the second slotted link guide can be arranged offset from one another at the first guide- and locking element.

In particular, the first, in particular linear guide track is arranged parallel to the second, in particular, linear guide track. Advantageously, the first linear guide track and the second linear guide track are arranged parallel to each other and, in particular, colinear with each other. Additionally, the first, in particular, linear guide track and the second, in particular, linear guide track can be arranged offset from one another and, in particular, without overlap.

The first slotted link slider and the second slotted link slider can be arranged parallel to each other and oriented in the same direction or in opposite directions.

The first slotted link guide and/or the second slotted link guide can be configured at least partially as slotted link openings. Additionally, the first slotted link guide and/or the second slotted link guide can include at least an inner guide surface, advantageously, two opposite guide surfaces for the first slotted link slider and/or the second slotted link slider. Alternatively, or additionally, the first slotted link guide and/or the second slotted link guide can include an outer support surface for the first slotted link slider and/or the second slotted link slider.

Thus, the term guide track can be interpreted so that
a) the guide track includes opposing guide surfaces guiding the slotted link slider or the slotted link sliders on both sides, in particular, through a two-sided contact with the opposing guide surfaces, or
b) wherein the guide track includes or forms a single inner or outer guide surface.

Additionally, the first, in particular linear guide track and/or the second, in particular linear guide track can be parallel to the door leaf when the door leaf is in the closed position or parallel to a vehicle longitudinal axis of the vehicle.

Last, not least, the first slotted link guide and/or the second slotted link guide can be configured as slotted link openings.

Particularly advantageously, the drive drives the door leaf, wherein a resultant movement of the door leaf drives the first pivot lever. Thus, the first pivot lever is driven by the drive device, e.g. indirectly or directly by the door leaf.

According to an advantageous embodiment, the door leaf driven by the drive drives the first pivot lever during an opening process of the door leaf,
a) wherein the first pivot lever disengages the first slotted link slider from the first, in particular linear guide track, in particular, moves the first slotted link slider out of the first in particular linear guide track, wherein the first slotted link slider is moved along the first in particular linear guide track in a first direction, and then the first pivot lever brings the first slotted link slider into engagement with the pivot portion, in particular moves the first slotted link slider into the pivot portion, wherein the first slotted link slider runs along the at least partially curved guide track and the pivot lever pivots until the door leaf has reached an opening position, and
b) wherein the first pivot lever moves the second slotted link slide along the second, in particular linear guide track.

According to an advantageous embodiment, the door leaf driven by the drive drives the first pivot lever during a closing process of the door leaf,
a) wherein the first pivot lever disengages the first slotted link slider from the pivot portion, in particular, moves the first slotted link slider out of the pivot portion and engages the first slotted link slider with the locking portion, in particular, moves the slotted link slider into the locking portion, wherein the first slotted link slider runs initially along the at least partially curved guide track of the first slotted link guide and then runs along the first, in particular, linear guide track in a second direction that is opposite to the first direction, and
b) wherein the first pivot lever moves the second slotted link slider along or in or at the second, in particular, linear guide track.

Since the drive device drives the door leaf, wherein the first pivot lever is coupled to the door leaf, e.g. by support rollers, in a slidable and pivotable manner, the first pivot lever is also indirectly driven while the driving is performed by the drive device and the first slotted link slider and the second slotted link slider are driven together with the first pivot lever. Therefore, the first pivot lever is in particular exclusively driven by the door leaf, which, in turn, is driven by the drive device.

An advantageous embodiment of the swinging-sliding door system is configured so that
a) the first slotted link slider includes at least one roller, in particular, with a circular cross-section, that rolls along the first slotted link guide, or at least one pin, in particular, with a circular cross-section, that slides along the first slotted link guide, and/or
b) wherein the second slotted link slider includes at least one roller, in particular, with a circular cross-section that rolls along the second slotted link guide or at least one pin, in particular, with a circular cross-section that slides along the second slotted link guide.

Using at least one roller advantageously generates little friction and wear and an improved support of the first pivot lever.

According to an advantageous embodiment of the swinging-sliding door system, the first slotted link guide is configured as a first slotted link opening and the first, in particular, linear guide track is configured with a closed end and with an open end, which is adjoined by the at least partially curved guide track.

The closed end can include a particularly semicircular cross section with an inner diameter into which the first slotted link slider can penetrate positively form locking and in particular with little clearance, in particular, when the first slotted link slider includes a cylindrical or circular cross section. Advantageously, the inner diameter of the semicircular cross section of the closed end of the first, in particular, linear guide track is slightly greater than an outer diameter of the first slotted link slider.

A transition between the open end of the first, in particular, linear guide track and the at least partially curved guide track of the first slotted link guide can be configured as an edge or as a radius viewed in cross section.

Analogously, the second slotted link guide can be configured as second slotted link opening with two closed ends, wherein at least one closed end has a cross section that is in particular semicircular and an inner diameter in which the second slotted link slider can penetrate form locking and in particular with a small amount of clearance, in particular, when the second slotted link slider has a complimentary cylindrical or circular cross section.

According to an advantageous embodiment,
a) the first slotted link slider and/or the second slotted link slider is/are arranged at the first pivot lever, and the first slotted link guide and/or the second slotted link guide is/are configured at the first guide- and locking element, or
b) the first slotted link slide and/or the second slotted link slide is/are configured at the first guide and locking element, and the first slotted link guide and/or the second slotted link guide is/are configured at the first pivot lever.

Advantageously, the swinging-sliding door system is configured so that the first slotted link slider and the second slotted link slider is/are fixed or attached at the first pivot lever, and the first slotted link guide and the second slotted link guide are configured in or at the first guide- and locking element. Advantageously, the first slotted link slider and the second slotted link slider protrude from the first pivot lever in a perpendicular direction with identical orientation or with opposite orientation.

Advantageously, the swinging-sliding door system is configured so that the first slotted link guide and the second slotted link guide are
a) in one plane, or
b) in parallel planes, or
c) in planes oriented perpendicular to one another.

A particularly high level of guide stiffness is achieved by an advantageous embodiment of the swinging-sliding door system, wherein
a) the first slotted link device is arranged in a first plane, and
b) the first pivot lever is at least slidingly supported relative to a second guide- and locking element by a second slotted link device, wherein the second guide- and locking element is fixed at the door frame, in particular, in a rigid manner,
c) wherein the second slotted link device includes at least one additional slotted link guide in a second plane, which is oriented, in particular, perpendicular to the first plane,
d) wherein the at least one additional slotted link device extends parallel at least to the second slotted link device, and at least one additional slotted link slider connected with the first guide and locking element is supported in the at least one additional slotted link guide, in particular, in the same direction as the second slotted link slider is supported in the second slotted link guide.

According to an advantageous variation of the embodiment recited supra, the first slotted link guide and the second slotted link guide are configured at or in a first plate-shaped element, forming a first guide- and locking element. The additional slotted link guide recited supra can also be configured as a slotted link opening with at least one closed end, in particular, with two closed ends, and can be configured at or in a second plate-shaped element as the second guide- and/or locking element. Thus, the first plate-shaped element or the first guide- and locking element can be arranged, in particular, perpendicular to the second plate-shaped element or to the second guide- and locking element. Further improving upon this embodiment, the first pivot lever and the second guide- and locking element can be connected with one another by the second slotted link slider.

According to an advantageous embodiment, the swinging-sliding door system can also include a second pivot lever that is pivotably connected at the door frame with one end and that supports the second slotted link slide at another end, wherein, in particular, the second pivot lever pivots relative to the door frame along the second slotted link guide during a movement of the second slotted link slider. Thus, in particular, the first pivot lever and the second pivot lever are connected with one another by the second slotted link slider, wherein the second slotted link slider penetrates through the second slotted link guide of the first guide- and locking element.

This embodiment has the advantage that the pivotability of the first pivot lever about two axes, namely, about the second slotted link slider and about the attachment of the second pivot lever at the door frame, allows the curved movement path of the first pivot lever and thus also of the door leaf to be flexibly adapted to the respective requirements. This embodiment also comes with less stringent requirements regarding tolerances and prevents wedging.

The swinging-sliding door system facilitates arranging the first pivot lever, optionally, the second pivot lever, and the at least one guide- and locking element in an area of a lower or upper edge of the door leaf.

The invention relates to a vehicle, in particular, a rail bound vehicle, configured to transport passengers, and including at least one swinging-sliding door system described supra.

### BRIEF DESCRIPTION OF THE DRAWINGS

Advantageous embodiments of the invention are subsequently described with reference to drawing figures wherein:

FIG. 1 illustrates a schematic front view of a swinging-sliding door system, including two door leaves according to an advantageous embodiment;

FIG. 2 illustrates a blown up side view II of an advantageous embodiment of the guide- and locking device of the sliding-pivoting door system of FIG. 1;

FIG. 3 illustrates a sectional view of the guide- and locking device of FIG. 2 along the line III-III of FIG. 1 in a situation where the door leaves are closed;

FIG. 4 illustrates a sectional view of the guide- and locking device of FIG. 2 along the line III-III of FIG. 1 at a beginning of an opening process of the door leaf;

FIG. 5 illustrates a sectional view of the guide- and locking device of FIG. 2 along the line III-III in FIG. 1 in a situation where the door leaves are open;

FIG. 6 illustrates an enlarged perspective view of an additional embodiment of the locking and guide device of the swinging-sliding door system of FIG. 1 in a situation where the door leaves are closed;

FIG. 7 illustrates a sectional view of the guide- and locking device of FIG. 6 in a situation in which the door leaves are closed;

FIG. 8 illustrates a sectional view of the guide- and locking device of FIG. 6 in a situation where the door leaves are open;

FIG. 9 illustrates a blown-up sectional view of another embodiment of the guide- and locking device of the swinging-sliding door system of FIG. 1 in a situation where the door leaves are closed;

FIG. 10 illustrates a blown-up sectional view of the guide- and locking device of FIG. 9 in a situation in which the door leaves move in an opening direction;

FIG. 11 illustrates an enlarged sectional view of the embodiment of the guide- and locking device of FIG. 9 in a situation where the door leaves are open.

### DETAILED DESCRIPTION OF THE INVENTION

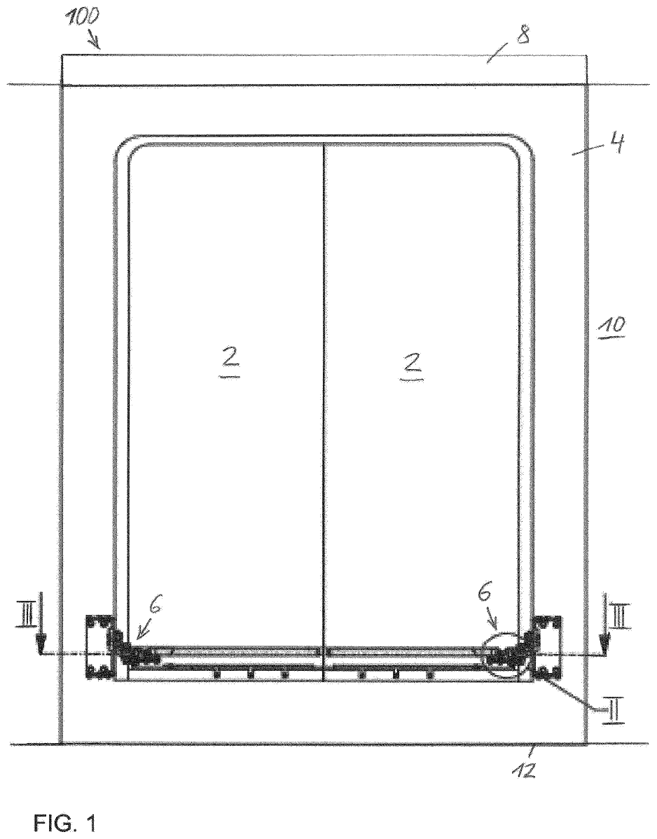

FIG. 1 shows a swinging-sliding door system 100 of a rail bound passenger transport vehicle, the swinging-sliding door system including two door leaves 2 closing a door opening configured in a door frame 4. A guide- and/or locking device 6 that will be described in detail infra is not limited to a two-leaf swinging-sliding door system 100, but can also be used for a single leaf swinging-sliding door system that only includes one leaf. In this swinging-sliding door system, the door leaves 2 which are swinging-sliding door leaves travel on a movement path that includes a linear movement and a curved movement.

Each door leaf 2 is supported slidable and pivotable at support rods in an upper portion of the door leaf through supports. Additionally, the upper portion of the door opening includes a drive 8 that is schematically illustrated in FIG. 1, wherein the drive drives and moves the door leaves 2 to open and close the door opening and moves the door leaves on a linear path along an outer vehicle wall 10.

Advantageously, each door leaf 2 includes a support and locking device 6 that is respectively associated with a door panel arranged at the respective door leaf 2 on a side oriented towards a vehicle interior. A respective support-and locking device 6 is arranged at the door frame 4 advantageously at a level of a lower side edge of the left and right door leaf 2 at a bottom side of each door leaf or door panel. It is also conceivable to arrange the support and locking devices 6 at any level of the door leaves 2 or the vertical posts of the door frame 4, wherein the support and locking devices 6 are advantageously arranged in an area of a vehicle base 12.

The guide and locking devices 6 are arranged and configured to guide and lock the door leaves 2, wherein the locking is performed in particular in a direction perpendicular to a vehicle longitudinal direction or a vehicle outer wall 10, thus e.g. in a closed position of the door leaves 2. Subsequently, a configuration and function of a guide- and locking device 6 is described in an exemplary manner that is representative for all additional guide and locking devices 6.

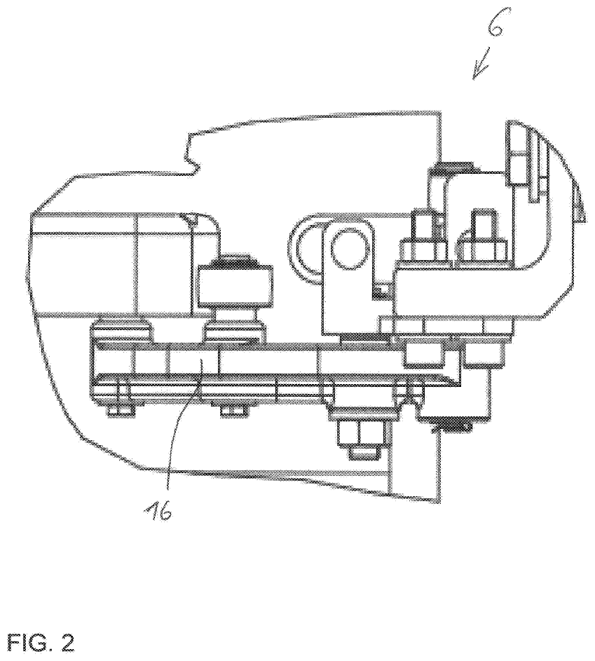

The advantageous embodiment of the guide- and locking device 6 illustrated in FIG. 2-5 includes a first guide- and locking element 14, which is fixed in particular in a rigid manner at a vertical post of the door frame 4. The guide and locking element 14 is thus formed e.g. by a plate attached at the door frame 4. Additionally, the guide- and locking device 6 includes a first pivot lever 16, which is supported on one side e.g. by two guide rollers 18 in or at a linear guide 20 of the respective door frame 2 in a linear moveable and pivotable manner, and supported on another side by a first slotted link device 72, relative to the first guide and locking element 14 in a slidable and pivotable manner, wherein the first slotted link device 72 includes a first slotted link slider 22, arranged e.g. at the first pivot lever 16 and supported in a first slotted link guide 24, configured e.g. as a first slotted link opening, e.g. of the first guide and locking element 14 and a second slotted link slider 26, arranged e.g. at the first pivot lever 16 and supported in second a slotted link guide 28, configured e.g. as a second slotted link opening, e.g. of the first guide- and locking element 14 in a slidable and pivotable manner. Therefore, the guide- and locking device 6 includes the first and second slotted link slider 22, 26 and the first and second slotted link guide 24, 28 in addition to the first pivot lever 16.

Therefore, the first slotted link guide 24 includes a locking portion 30, including a first, in particular, exclusively straight guide track 32 for the first slotted link slider 22 and a pivot portion 34 adjoining the locking portion 30 and including a curved support path 36 for the first slotted link slider. The second slotted link guide 28 includes a second, in particular, exclusively linear, guide track 38 for the second slotted link slider 26. Additionally, the first linear guide track 32, the second linear guide track 38, and the curved guide track 36 are arranged in the first guide and locking element 14 as pass-through openings without overlap or intersection.

The first linear guide track 32 is thus advantageously offset from the second linear guide track 38 at or in the guide- and locking element and runs in parallel and, in particular, colinear with the second linear guide track 38, wherein both linear guide tracks 32, 38 run essentially parallel to the vehicle longitudinal direction or to the outer vehicle wall 10. The first slotted link guide 24 and the second slotted link guide 28 are advantageously arranged offset from one another at the first guide- and locking element 14.

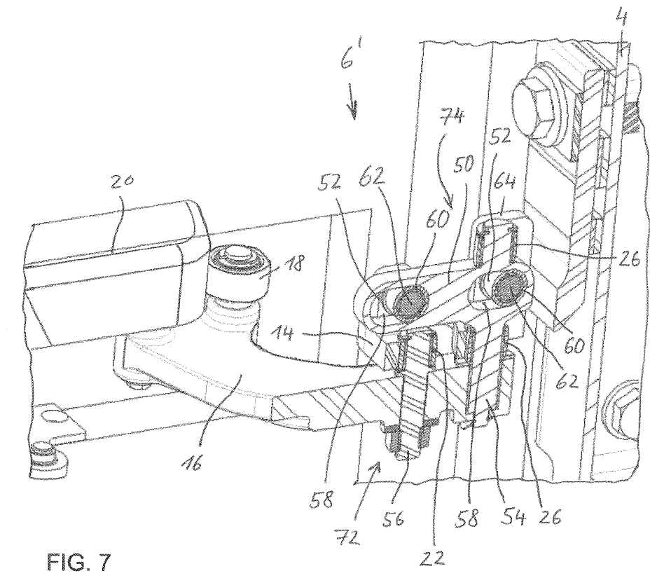

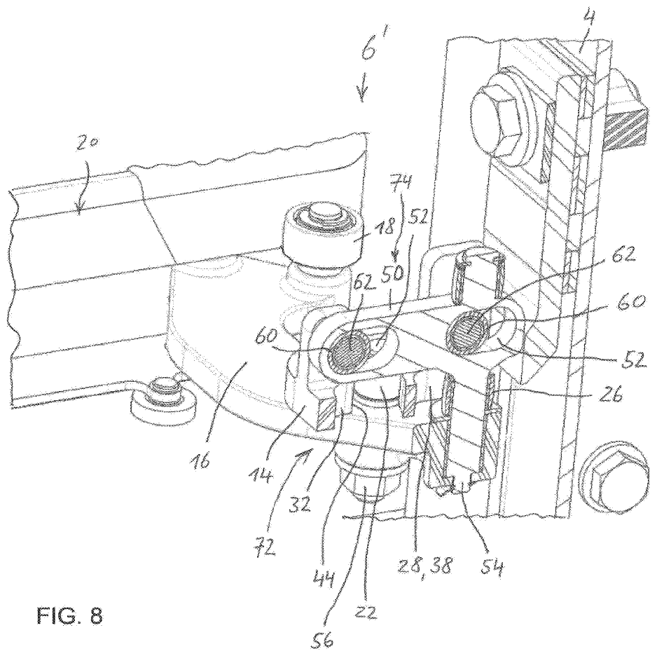

Advantageously, all guide tracks 32, 36, and 38, respectively include two opposite guide surfaces 40 for the first slotted link slider 22 and for the second slotted link slider 26 in order to provide a defined and stiff support for the slotted link slider 22, 26. Advantageously, both slotted link sliders 22, 26 or at least one slotted link slider are/is configured as rollers, wherein the first slotted link slider 22 includes a first roller rotatable about a first roller axis 56 FIGS. 7 and 8), and the second slotted link slider 26 includes a second roller rotatable about a second roller axis 54. The two roller axes 54, 56 are then supported torque-proof and axially fixed in openings of one end of the first pivot lever 16, in particular torque proof and axially fixed.

The rollers are rotatably supported at the roller axes, which e.g. protrude in parallel from a side surface of the first pivot lever 16. The rollers then contact the opposite guide surfaces 40 of the guide tracks and roll along the guide surfaces 40. Alternatively, the slotted link sliders 22, 26, or at least one slotted link slider, can also be configured as pins, which slide in the guide tracks 32, 36, 38 or the slotted link guides 24, 28. A combination of rollers and pins is also conceivable.

Additionally, the first linear guide track 32 is configured with a closed end 42 and an open end which adjoins the curved guide track 36. The closed end 42 can include, in particular, a semicircular cross section with an inner diameter into which the first slotted link slider 22 configured as a first roller can penetrate form locking and in particular with a small amount of clearance. Advantageously, the inner diameter of the semicircular cross section of the closed end 42 of the first linear guide track 32 is approximately identical with or slightly smaller than the outer diameter of the first roller which forms the first slotted link slider 22.

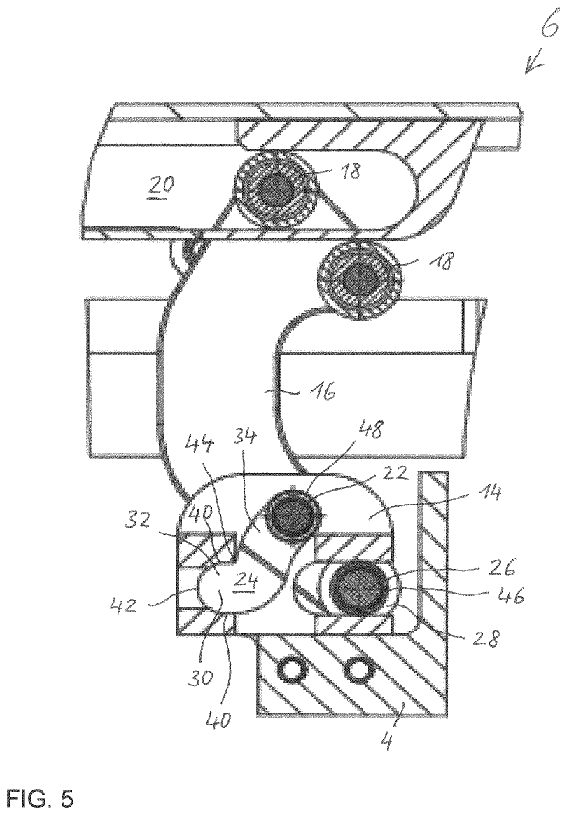

A transition between the open end of the first linear guide track 32 and the curved guide track 36 of the first slotted link guide 24 can be configured in a cross section as an edge 44 as evident in particular from FIG. 5.

Analogously, the second linear guide track 38 can be configured with two closed ends 46, which respectively include a semicircular cross section with an inner diameter in which the second roller can penetrate form locking and, in particular, with little clearance, in particular, when the second roller includes a complementary cylindrical or circular cross section.

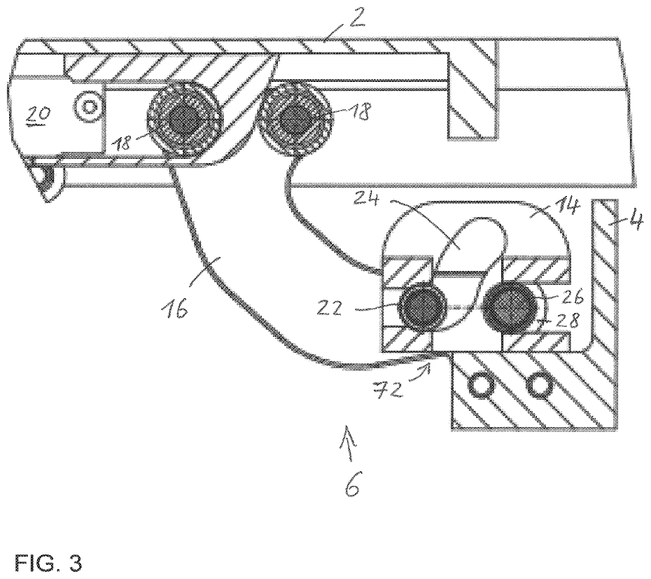

As evident from FIG. 3-5, the first slotted link slider 26 is arranged at the first pivot lever 16, so that the second slotted link slider 26 is not coaxial with, but offset from the first slotted link slider 22.

As illustrated in FIG. 3, the closed position of the door leaf 2 is configured with the first roller moved as a first slotted link slider 22 into the closed end 42 of the first linear guide track 32 of the locking portion 30 of the first slotted link guide 24 positively form locking and advantageously contacts the closed end 42 which forms a stop for the first roller, configured as the first slotted link slider 22. This prevents a movement of the door leaf 2 perpendicular to the first linear guide track 32, and, in particular, also perpendicular to the second guide track 38 which causes a locking of the door leaf 2 in the closed position in this direction. In the locked and closed position of the door leaf, the second roller configured as the second slotted link slider 26 also contacts a closed end 46 of the second linear guide track 38, which is complementary to the second roller with a semicircular cross section like the other closed end 46.

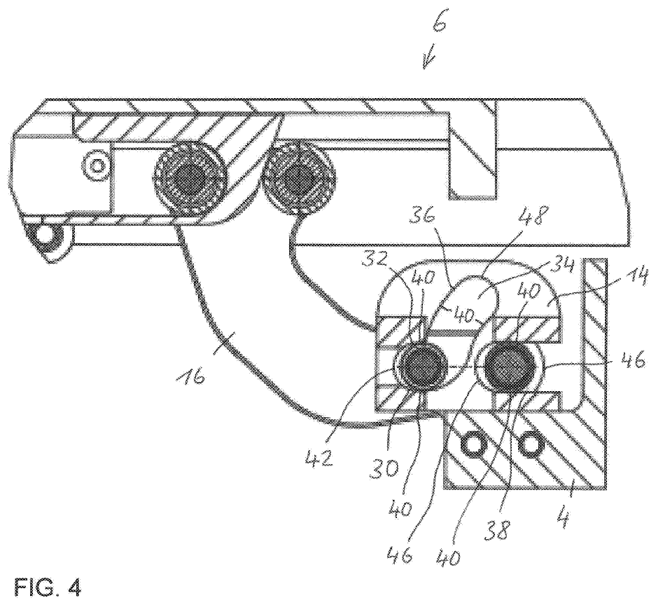

When the door leaf 2 begins to open according to FIG. 4, the second roller, configured as the second slotted link slider 22, rolls along the second linear guide track 38 and the first roller configured as the first slotted link slider 22, rolls along the first linear guide track 32, respectively in a first direction. The first roller only rolls until the edge 44 is reached, which forms a transition between the first linear guide track 32 (the locking portion 30) and the curved guide track 36 (the pivot portion 34).

Further along the opening travel of the door leaf 2, the first roller configured as the first slotted link slider 22 moves out of the first linear guide track 32 as illustrated in FIG. 5 and then engages the curved guide track 36, configured as pivot portion of the first slotted link guide 24, moves in particular into the pivot portion 34, wherein the first roller configured as the first slotted link slider 22 moves along the curved guide track 36 of the first slotted link guide 24 to a closed end 48 of the curved guide track 36 which is advantageously also formed complementary semicircular to the first roller, and then functions as a stop for the first roller. Then, the door leaf 2 has reached the opening position.

The second roller, configured as the second slotted link slider 26, moves in a time-parallel manner within the second linear guide track 38 further in the first direction until reaching the other closed end 46 of the second linear guide track 38, which then forms a stop. When opening the door leaf 2, the first pivot lever 16 pivots about the second roller, thus configured as the second slotted link slider 26 which forms a pivot axis of the first pivot lever 16 when the door leaf 2 is being moved, in particular, a door frame side pivot axis of the first pivot lever 16.

A reverse sequence of FIG. 3-5 shows that the first roller configured as the first slotted link slider 22 moves out of the curved guide track 36 configured as the pivot portion 34 during a closing movement of the door leaf 2, wherein the first slotted link slider 22 then moves into the first linear guide track 32 configured as the locking portion 30, wherein the first roller configured as the first slotted link slider 22 initially runs along the curved guide track 36 and then along the first linear guide track 32 in a second direction that is opposite to the first direction. This movement of the first roller configured as the first slotted link slider 22 continues until the first roller impacts the closed end 42 of the first linear guide track 32 or moves into the closed end. The second roller configured as the second slotted link slider 26 moves at the same time from the one closed end 46 of the second linear guide track 38 to the other closed end 46 also in the second direction. Thus, the two slotted link sliders perform a synchronized movement in the first and second slotted link guide 24, 28.

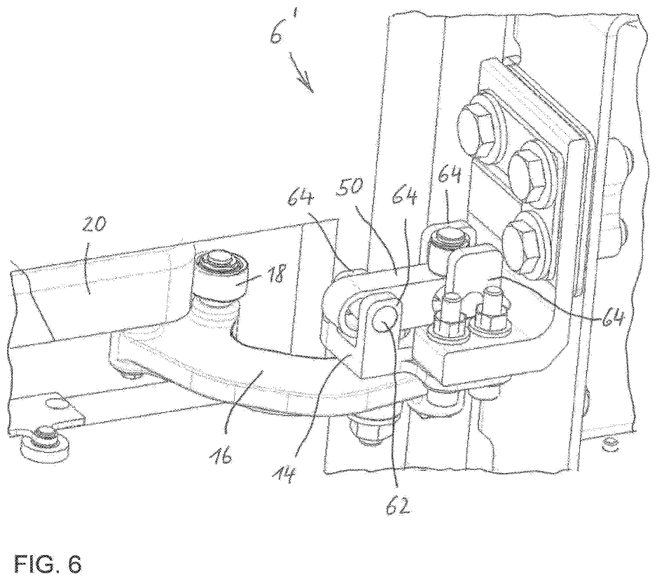

The embodiment shown in FIG. 6-8 of a guide- and locking device 6′ differs from the advantageous embodiment 6 described supra in that the first pivot lever 16 is additionally supported by a second slotted link device 74 so that the first pivot lever 16 is slidable and pivotable relative to a second guide and locking element 50. Thus, the second, e.g. also plate-shaped guide- and locking element 50 is provided with at least one additional slotted link guide, thus e.g. two additional slotted link guides 52, wherein the second guide and locking element is arranged, e.g. in a second plane which is, e.g. perpendicular to a first plane in which the first guide and locking element 14 is arranged in addition to the partially visible plate-shaped first guide and locking element 14 with the first slotted link guide 24 and the second slotted link guide 26 as illustrated in FIGS. 3-5.

Thus, the first slotted link guide 24 and the second slotted link guide 28 are configured in a first plate-shaped element as the first guide- and locking element 14, and the two additional slotted link guides are configured in a second plate-shaped element as a second guide- and locking element 50. Thus, the first plate-shaped element or the first guide and locking element 14 is arranged e.g. perpendicular to the second plate-shaped element or to the second guide- and locking element 50.

A connection between the first pivot lever 16 and the second guide- and locking element 50 can thus be implemented in that a second roller axis 54 formed at the second guide and locking element 50 is supported, in particular, torque-proof and axially fixed in a second opening of the first pivot lever 16 as illustrated, in particular, in FIGS. 7 and 8. The second roller configured as the second slotted link slider 26 is rotatably supported at the second roller axis 54, wherein the second roller is configured to roll as a second slotted link slider 26 along the second linear support path 38 of the first guide- and locking element 14, like in the embodiment described supra.

FIGS. 7 and 8 also show the first roller axis 56 for the first roller, configured as the first slotted link slider 22, which is then supported, in particular, torque-proof and axially fixed in an opening of the first pivot lever 16. This first roller axis 56 then rotatably supports the first roller, configured as the first slotted links slider 22, wherein the first roller is configured as the first slotted link slider 22, is then configured to roll along the first slotted link guide 24 of the first guide and locking element 14.

The two additional slotted link sliders 52 are advantageously also configured as linear support tracks 58 with two respective closed ends, which are, in turn, configured complimentary to additional rollers configured as additional slotted link sliders 60 that are supported in the two additional linear guide tracks 58. Additionally, the two additional linear support paths 58 of the two additional slotted link guides are configured e.g. offset from one another and colinear with each other parallel to the second slotted link guide 28, this means to the second linear guide track 38.

The two additional rollers configured as additional slotted link sliders 60 are rotatably supported, e.g. at two additional roller axes 62, which are supported at lobes 64 that protrude perpendicular from the first plate-shaped guide- and locking element 14. Therefore, additional rollers configured as additional slotted link sliders 60 connected with the first guide- and locking element 14 are supported in a linear direction in the two additional slotted link guides 52, wherein the second roller configured as the second slotted link slider 26 is supported in the second slotted link guide 28 in the same linear direction.

When the second door leaf 2 is closed according to FIG. 6, the situation illustrated in FIG. 3 applies to the first guide and locking element 14 and the first and second slotted link sliders 22, 26 supported therein, because the first guide and locking element 14 is configured identically in this embodiment. Additionally, the additional rollers configured as additional slotted link sliders 60 are arranged at the other ends of the additional linear guide tracks 58 and are engaged therein as illustrated in FIG. 7.

FIGS. 4 and 5 show situations during an opening travel of the door leaf 2 for the first guide and locking element 14 and the first and second slotted link sliders 22, 26 supported therein. The additional rollers configured as additional slotted link sliders 60 run parallel thereto in the additional linear guide tracks 58 until they impact at one of their ends as illustrated in FIG. 8, which shows the situation where the door leaf 2 has reached the open position.

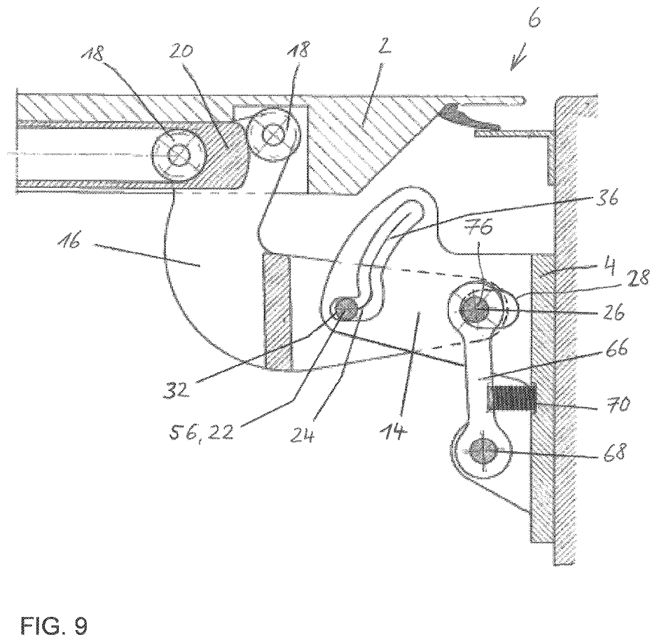

The additional advantageous embodiment of a guide- and locking device 6″ shown in FIG. 9-11 differs from the advantageous embodiment 6 described supra, in that the second slotted link slider 26 is additionally pivotably supported at the door frame 4 by a second pivot lever 66 and by a pivot joint 68. The pivot joint 68 at the door frame 4 is arranged at one end of the second pivot lever 66, and the other end of the second pivot lever 66 is connected with the second slotted link slider 26 by a pivot joint 76, wherein the second slotted link slider 26 then penetrates e.g. through the second slotted link guide 28. Thus, a pivot link 76 is formed at the end of the second slotted link slider 26, protruding from the second slotted link guide 28, wherein the pivot link 76 pivotably links the other end of the second pivot lever 66 with the second slotted link slider 26, wherein the pivot axis of the pivot joint 76 is coaxial with the second slotted link slider 26. Consequently, the second pivot lever 66 can pivot relative to the second slotted link slider 26 about the link 76. Additionally, the two ends of the e.g. approximately linear, second slotted link guide 28 can form stops for the second slotted link slider 26 when the second pivot lever 66 rotates about the pivot joint 68. The second pivot lever 66 can pivot about the pivot joint 68 relative to the door frame 4 during a movement of the door leaf 2 as far as permitted by the end stops of the second slotted link guide 28 relative to the second slotted link slider 26.

FIG. 9 shows a closed position of the door leaf 2 where the first roller configured as the first slotted link slider 22 contacts one end of the first linear guide track 32 and the second roller configured as the second slotted link slider 26 contacts one end of the second linear guide track 38. The second pivot lever 66 is in a first pivot position where it is additionally preloaded by the spring devices 70, wherein the first pivot position is then defined by the stop of the second roller configured as the second slotted link slider 26 at the other end of the second linear guide track 38.

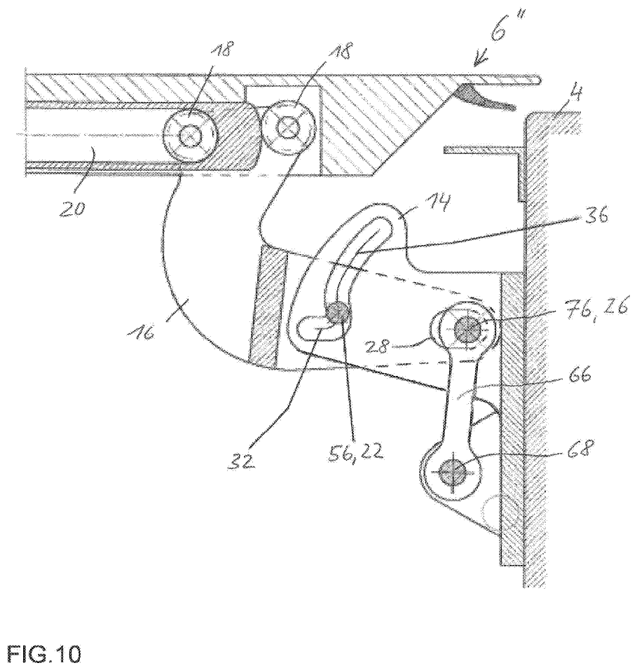

FIG. 10 shows the opening movement travel of the door leaf 2. The motions of guiding the first roller as a first slotted link slider 22 in the first slotted link guide 24 and of guiding the second roller configured as the second slotted link slider 26 within the second slotted link guide 28 are identical to the advantageous embodiment described supra and illustrated in FIG. 6.

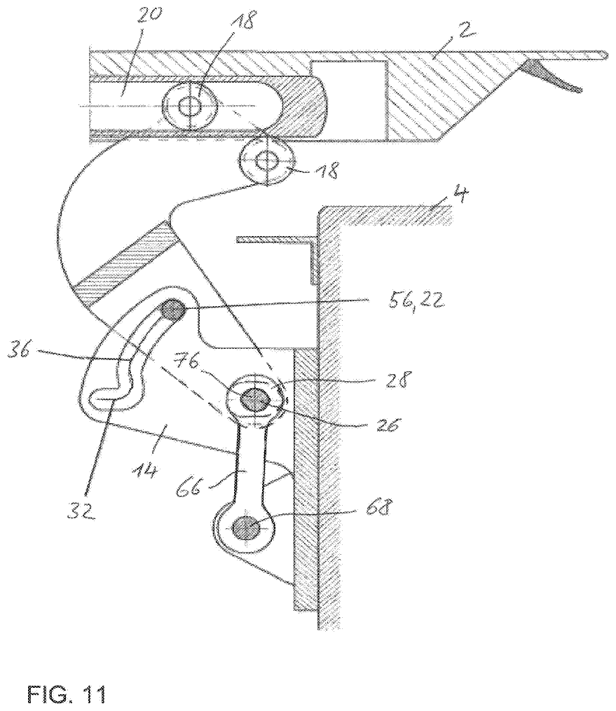

FIG. 11 shows the door leaf 2 in the open position where the second pivot lever 66 is pivoted into a second pivot position, which is then defined e.g. by the stop of the second roller, configured as the second slotted link slider 26 at one end of the second linear guide track 38.

### REFERENCE NUMERALS AND DESIGNATIONS

100 swinging-sliding door system
2 door leaf
4 door frame with door opening
6, 6′, 6″ guide- and locking device
8 drive
10 outer vehicle wall
12 vehicle floor
14 first guide- and locking element
16 first pivot lever
18 guide roller
20 linear guide
22 first slotted link slider
24 first slotted link guide
26 second slotted link slider
28 second slotted link guide
30 locking portion
32 first linear guide track
34 pivot portion
36 curved guide track
38 second linear guide track
40 guide surface
42 closed end
44 edge
46 closed end
48 closed end
50 second guide- and locking element
52 additional slotted link guide
54 second roller axis
56 first roller axis
58 additional linear guide track
60 additional slotted link slider
62 additional roller axis
64 lobe
66 second pivot lever
68 pivot joint
70 spring
72 first slotted link device
74 second slotted link device
76 joint

What is claimed is:

1. A swinging-sliding door system of a vehicle, the swinging-sliding door system comprising:
a door frame, including a door opening;
a door leaf, configured to open and close the door opening;
a drive, configured to drive the door leaf relative to the door frame along a path including a linear portion, and an arc-shaped or curved portion;
a guide- and locking device, configured to guide the door leaf and lock the door leaf at least in a closing position, the guide and locking device including:
a first guide- and locking element fixed at the door frame,
a first pivot lever, supported in or at the door leaf, and supported slidable and pivotable by a first slotted link device relative to the first guide- and locking element,
wherein the first slotted link device includes a first slotted link slider supported at or in a first slotted link guide and a second slotted link slider that cooperates with a second slotted link guide,
wherein the first slotted link guide includes a locking portion, and a pivot portion adjoining the locking portion,
wherein the first slotted link slider is interlocked at or in the locking portion in the closing position of the door leaf, and
wherein the second slotted link slider is non-coaxial with and offset from the first slotted link slider.

2. The swinging-sliding door system according to claim 1,
wherein the locking portion includes a first partially linear guide track for the first slotted link slider and/or
wherein the pivot portion includes an at least partially curved guide track for the first slotted link slider.

3. The swinging-sliding door system according to claim 2,
wherein the first slotted link slider cooperates with the first at least partially linear guide track in the closing position of the door leaf, and
wherein the first slotted link slider is moved into the first at least partially linear guide track, so that a movement of the door leaf is prevented at least perpendicular to the first at least partially linear guide track in the closing position of the door leaf.

4. The swinging-sliding door system according to claim 3,
wherein the first slotted link guide is configured as a first slotted link opening and the first at least partially linear guide track is configured with a closed end and with an open end, and
wherein the open end adjoins the at least partially curved guide track of the first slotted link guide,
wherein the closed end has a semicircular cross section with an inner diameter into which the first slotted link slider is able to penetrate and positively form lock in the inner diameter.

5. The swinging-sliding door system according to claim 4, wherein a transition between the open end of the first, at least partially curved guide track and the at least partially curved guide track of the first slotted link guide is configured as a corner or as a radius.

6. The swinging-sliding door system according to claim 1, wherein the second slotted link guide includes a second at least partially linear guide track, wherein the second slotted link slider is guided in or at the second at least partially linear guide track.

7. The swinging-sliding door system according to claim 2,
wherein the second slotted link guide includes a second at least partially linear guide track, wherein the second slotted link slider is guided in or at the second at least partially linear guide track, and
wherein the first at least partially linear guide track and the second at least partially linear guide track are arranged offset from one another and/or parallel with each other, and/or colinear with each other.

8. The swinging-sliding door system according to claim 1,
wherein the door leaf drives the first pivot lever during an opening movement of the door leaf,
wherein the first pivot lever moves the first slotted link slider out of engagement with the locking portion, and/or out of the locking portion and then into engagement with the pivot portion, wherein the first slotted link slider runs along the pivot portion, and
wherein the first pivot lever moves the second slotted link slider along or in the second slotted link guide until the door leaf has reached the open position.

9. The swinging-sliding door system according to claim 1,
wherein the door leaf drives the first pivot lever during a closing process of the door leaf,
wherein the first pivot lever moves the first slotted link slider out of engagement with the pivot portion and then into engagement with the locking portion, and moves the first slotted link slider into the locking portion, and
wherein the first pivot lever moves the second slotted link slider along or at or in the second slotted link guide until the door leaf has reached the closing position.

10. The swinging-sliding door system according to claim 1,
wherein the first slotted link slider includes at least one roller with a circular cross-section, that rolls along the first slotted link guide, or at least one pin, with a circular cross-section that slides along the first slotted link guide, and/or
wherein second slotted link slider includes at least one roller with a circular cross-section that rolls along the second slotted link guide or at least one pin with a circular cross-section that slides along the second slotted link guide.

11. The pivoting-sliding door system according to claim 1,
wherein the second slotted link guide is configured as a second slotted link opening, including at least one closed end, and
wherein the at least one closed end has a semicircular cross section with an inner diameter configured to be penetrated by the second slotted link slider positively form locking.

12. The swinging-sliding door system according to claim 1,
wherein the first slotted link slider and/or the second slotted link slider is arranged at the first pivot lever, and the first slotted link guide and/or the second slotted link guide is configured at the first guide- and locking element, or
wherein the first slotted link slider and/or the second slotted link slider is configured at the first guide- and locking element, and the first slotted link guide and/or the second slotted link guide is configured at the first pivot lever.

13. The swinging-sliding door system according to claim 1, wherein the first slotted link guide and the second slotted link guide are arranged
in one plane, or
in parallel planes, or
in planes oriented perpendicular to one another.

14. The swinging-sliding door system according to claim 1,
wherein the first slotted link device is arranged in a first plane, and
wherein the first pivot lever is at least slidingly supported relative to a second guide- and locking element by a second slotted link device,
wherein the second guide- and locking element is fixed at the door frame, and
wherein the second slotted link guide includes at least one additional slotted link guide arranged in a second plane, which is oriented perpendicular to the first plane,
wherein the at least one additional slotted link guide extends parallel at least to the second slotted link guide, and at least one additional slotted link slider connected with the first guide and locking element is supported in the at least one additional slotted link guide, in particular, in the same direction as the second slotted link slider is supported in the second slotted link guide.

15. The swinging-sliding door system according to claim 14, wherein the first pivot lever and the second guide- and locking element are connected with each other by the second slotted link slider.

16. The swinging-sliding door system according to claim 1, wherein the first slotted link guide and/or the second slotted link guide are configured as slotted link openings.

17. The swinging-sliding door system according to claim 1, wherein a second pivot lever is provided which is pivotably connected at one end with the door frame and at another end with the second slotted link slider.

18. The swinging-sliding door system according to claim 17,
wherein the first pivot lever and second pivot lever are connected with one another by the second slotted link slider,
wherein the second slotted link slider penetrates through the second slotted link guide of the first guide- and locking element.

19. The swinging-sliding door system according to claim 1, wherein at least the first pivot lever and the at least one first guide and locking element is arranged in an area of a lower or upper door edge of the door leaf.

20. The swinging-sliding door system according to claim 1, wherein the second slotted link slider forms a pivot axis of the first pivot lever when the door leaf is moved.

21. A vehicle, comprising: the swinging-sliding door system according to claim 1.
